(19) United States
(12) Patent Application Publication
(10) Pub. No.: US 2006/0167766 A1
(43) Pub. Date: Jul. 27, 2006

(54) System for and method of providing a credit to a customer

(76) Inventors: Mark Kassel, Verona, WI (US); Mark Bradford, Greenfield, WI (US)

Correspondence Address: FOLEY & LARDNER LLP, 150 EAST GILMAN STREET, P.O. BOX 1497, MADISON, WI, 53701-1497, US

(21) Appl. No.: 11/340,039

(22) Filed: Jan. 26, 2006

Related U.S. Application Data
(60) Provisional application No. 60/647,486, filed on Jan. 27, 2005.

(51) Int. Cl. G06Q 30/00

(52) U.S. Cl. 705/26

(57) ABSTRACT

A method of providing a credit to a customer of a resort or casino for use with goods or services sold by the resort or casino while allowing the customer to retain his privacy concerning the consumption of the particular resort or casino goods or services with which the credit is utilized.

### CROSS-REFERENCES TO RELATED APPLICATIONS

This application claims the benefit of U.S. Provisional Application No. 60/647,486, filed Jan. 27, 2005, the entire contents of which are incorporated herein by reference.

### TECHNICAL FIELD

The present invention is directed to systems and methods in which credits are provided to a customer. More specifically, the present invention is drawn to a method of providing a customer a credit that may be used to purchase gambling tokens, alcohol, tobacco, and other entertainment.

### BACKGROUND OF THE INVENTION

Casinos and other resorts are popular destinations for many people. To help attract customers, such destinations have developed many programs, rebates and giveaways to attract potential customers.

One popular method of attracting customers is to offer international credit cards, such as Visa and MasterCard, with reward programs. These reward programs, such as awarding points for dollars charged by a purchaser to such credit cards, are used to provide credit to the purchaser in the form of hotel rooms, airline tickets, or even cash credits which can be used to make additional purchases with the credit card. The reward system for a particular credit card is often tied to a particular resort. The cash value of these reward systems are generally less than five percent of the value of the items purchased, and typically less than two percent. Typically, large dollar value purchases are required to earn any significant reward. Also, such reward programs do not allow the card holder to use the reward credit immediately upon purchase.

Also, product rebates, including instant rebates are known in art. These rebates provide cash or credit when using a major credit card for the purchase of specific goods and services. However, these rebates are often time consuming and complicated to obtain, in order to discourage purchasers from obtaining the rebate. Even if the rebate is given as an instant rebate, the rebate is given as cash or credit to a major credit card, and the purchaser is free to use the cash or credit received at any retailer, not just the retailer from whom the rebated goods or services were purchased.

Casinos have begun various point based system awards based on dollars spent gambling. For every dollar spent in a casino, the casino issues a point or credit that can be used for future purchases at the casino, including food, lodging and gambling. These credits are a small percentage of the dollar value spent, typically awarding as gambling credit less than one percent of the total dollars spent by the customer under such a program. Also, these programs are only effective with those customers who already spend large amounts of money on gambling. For example, casinos in Las Vegas have approximately forty million visitors a year, and most visitors spend more money on food and shopping than gambling. There remains a need to find additional means for casinos and resorts to attract additional dollars, including gambling dollars, from their visitors who do not typically spend large amounts of money gambling.

Some customers who stay at casinos and other resorts are reluctant to purchase items and services that will be described on receipts and credit card bills as gambling credit, tobacco, shows, revues, and other entertainment services, souvenirs and luxury items. A need exists to allow such customers the ability to purchase such items and services in an anonymous and private manner.

### SUMMARY OF THE INVENTION

The present invention is directed to systems and methods of providing a credit having no cash value to a customer upon purchase by the customer of a good and/or service for a fee from a seller and wherein the seller returns at least ten percent of the fee to the customer as a credit.

In another embodiment, the present invention teaches a system and method of providing a credit to a customer who purchases for a fee a good and/or service from a seller, wherein the seller returns a portion of the fee to the customer, wherein the credit can only be used to purchase one or more non-staple items such as gambling credit.

In a further embodiment, the present invention teaches a system and method of providing a credit to a customer who purchases for a fee a good and/or service from a seller, wherein the seller returns a portion of the fee to the customer as a credit, wherein the credit is available to the customer for use in less than twenty four hours after paying the fee.

In still another embodiment, the present invention provides a method of providing a credit to a customer who purchases from a fee a good and/or service from a seller, wherein the seller returns a portion of the fee to the customer as a credit, wherein the credit is not listed on a receipt provided by the seller to the customer, and wherein the requested good and/or service is listed on the receipt.

### DETAILED DESCRIPTION OF THE INVENTION

As used herein, the following terms are defined as follows:

“No cash value” means that the credit may not be used generally or redeemed for cash, but may only be used for specific purchases from specific seller(s).

“Non-staple item” means gambling credit, alcohol, souvenirs and tobacco.

“Gambling credit” means any form of exchange that may be used exclusively for gambling, including but not limited to, credit cards, tokens, chips, and slips.

“Gambling” means any game of chance, including but not limited to, slot machines, dice games, card games, bets and wagers made on the outcome of events including but not limited to sporting events and races.

“Staple item” means food, beverages, hotel rooms, restaurant services, car rentals, airline tickets, and other travel expenses.

The present invention is drawn to methods of providing credits to customers of resorts and casinos in order to allow customers to purchase staple items and immediately have a portion of the purchase price of the staple item refinded to the customer in the form of credit. A resort may comprise one or more hotels, casinos, amusement rides, taverns, theaters or combinations thereof. The present invention allows the customer to purchase non-staple items while maintaining their privacy with respect to such purchases. In one embodiment, this credit may only be used for the purchase of non-staple items. In a further embodiment, the non-staple items are gambling credit. The present invention also allows the customer to use the credit received for purchases limited to gambling credit, tobacco, shows, revues, and other entertainment services, souvenirs and luxury items. In one embodiment, the purchase by the customer generates a receipt by the seller that may or may not be itemized and does not list the credit as having been received by the customer, thus allowing the customer to receive the credit anonymously and privately. In one embodiment, this receipt is delivered to the customer contemporaneously upon payment of the fee by the customer. In other embodiments, this receipt is delivered to the customer in less than 5 minutes, less than 10 minutes, less than 30 minutes, less than one hour or less than 24 hours after payment of the fee by the customer. The credit may be given as tokens, a separate receipt, on a debit card, internal voucher or any other method commonly known in the art.

In at least one embodiment, the present invention is advantageous over the prior art rebate and reward programs which often issue either cash or a general credit which can be used with multiple sellers, as the credit given in the present invention may be restricted to be used only with goods and services offered by the seller providing the credit. In one embodiment, the credit is given as gambling credit. In another embodiment, the credit is given as restricted gambling credit, in that the credit may only be used for gambling and may not be redeemed for cash but must be used for gambling. In this embodiment, any winnings from gambling with such restricted gambling credit may then be converted into cash. For example, the restricted gambling credit could be issued as a specially marked chip or token, which could not be redeemed for cash and could only be used for gambling. Such special markings would make it easy for the seller to prevent such gambling credit to simply be redeemed for cash. Unlike prior art provisions for gambling credit or rebates, the present invention is advantageous in that it may prevent the customer from spending such credit on a broad array of items, many of which would not be purchased from the seller. In one embodiment, the present invention seeks to ensure that all the fee paid by the customer to the seller, although returned in part in the form a credit, is ultimately spent with the seller.

Unlike typical rebates and reward programs known in the art, the credits issued to the customer according to the present invention may be a significant portion of the purchase price. The credit resulting from the purchase of items and/or services in one embodiment is at least ten percent of the purchase price of the item or service purchased. In other embodiments, the credit is at least fifteen, at least twenty, at least twenty five, at least thirty, at least thirty five, at least forty, at least forty five, at least fifty percent or at least seventy five percent of the purchase price of the particular item or service. In one embodiment of the present invention, the customer may specify the percentage of the credit, which will affect the purchase price accordingly.

In the present invention, the credit may have no cash value, and may be used only to obtain additional items and services from the selling party. Alternatively, the credit may be in form of tokens, house credit cards, credit slips etc. that are limited to use with non-staple items.

The credit of the present invention may be immediately available to the customer following payment for the purchase. Unlike typical rebate and reward programs of the prior art, which require hours, days or even months for the purchaser to be able to use credits associated with a particular purchase, the present invention may allow for the customer to have the credit available for use within a short time after the purchase. Such time period may be less than five minutes, less than fifteen minutes, less than one hour or less than one day, depending on the desire of the selling party.

The credit may be issued as distinct and individual chits, chips, or other forms suitable for appropriate redemption. The credit may also be issued to a temporary credit card which is assigned to an individual. As discussed below, the percentage amount of the purchase price that is rebated to credit card may be fixed, or may be variable in any percentage desired by either the individual or entity issuing the credit. The credit card could then be used directly in gaming machines for use with gaming machine credit or otherwise redeemed.

The credit may be given out via staple item purchases. In one embodiment, restaurant menus within the resort or casino will issue a credit with each item purchased. Alternatively, the credit may be associated only with specific menu items and not others, or each item could be available in multiple prices, with a standard version of the item being sold which does not include and credit as well as premium versions of the item including various amounts of credit. The credit given to the customer for purchasing the premium version can be the entire cost difference between the premium version and the standard version, or some percentage of the difference in price, wherein the percentage is less than one hundred percent. The credit may alternatively be given as a flat rate per item purchased rather than a percentage of the item cost.

The invention is further directed to systems for providing a credit to a customer. Such systems may be computer systems or software which contains programs to execute the methods of the present invention.

The invention is further described in the following non-limiting examples.

### EXAMPLES

### Example 1

### Restaurant Service Resulting in a Gaming Credit

A guest in a casino has lunch at a restaurant within the casino. The restaurant menu lists a number of items that include gambling credit. The gambling credit is listed along side each item on the menu. For example, the price of a hamburger is twenty dollars, which includes ten dollars worth of gaming tokens. When the customer orders the hamburger, the itemized bill the customer receives reflects a charge of twenty dollars for the hamburger without reference to the gambling credit received, thereby allowing the customer to receive the gaming tokens in anonymity.

### Example 2

### Room Service Resulting in a Non-Staple Credit

A guest in a casino hotel orders room service. The room service menu lists a number of items that include non-staple credit. For example, the price of a hamburger may be twenty dollars, which includes ten dollars worth of gaming tokens. When the customer orders the hamburger, the itemized invoice reflects a charge of twenty dollars for the food item without reference of the gambling credit received.

### Example 3

### Restaurant Service with Premium Pricing—Full Credit

A guest in a casino has lunch at a restaurant within the casino. The restaurant menu lists two prices for each item on the menu, a first price for a standard version and a second higher price for the premium version of the same item. Items purchased at the price of the premium version result in gaming credit or non-staple credit to be given to the customer in an amount equal to the difference between the price of the standard version and the price of the premium version. The itemized invoice reflects only the charge made for the premium version of the item purchased and does not reference the gaming credit or non-staple credit. The credit is provided to the customer upon receipt of payment for invoiced item(s), and may be used immediately thereafter.

### Example 4

### Restaurant Service with Premium Pricing—Partial Credit

A guest in a casino has lunch at a restaurant within the casino. The restaurant menu lists two prices for each item on the menu, a first price for a standard version and a second higher price for the premium version of the same item. Items purchased at the price of the premium version result in gaming credit or non-staple credit to be given to the customer in an amount less than the difference between the price of the standard version and the price of the premium version. The itemized invoice reflects only the charge made for the premium version of the item purchased and does not reference the gaming credit or non-staple credit thereby allowing the customer to purchase non-staple items and/or participate in gambling while retaining the customer's anonymity and privacy with respect to such purchases/activity. The amount of credit is a percentage less than one hundred percent of the difference between the standard version and the premium version.

### Example 5

### Lodging Services Resulting in a Non-Staple Credit

A guest in a resort rents a room for four hundred dollars per night. For each night the guest rents in the room, the resort issues a credit to the guest in the amount of one hundred dollars. This credit may only be used to purchase non-staple items within the resort. The itemized bill for the room reflects only a room charge and does not reflect the credit received for use with non-staple items thereby preserving the anonymity and privacy of the guest in relation to non-staple purchases.

### Example 6

### Lodging Services Resulting in a Gaming Credit

A resort guest rents a room for three hundred dollars per night. For each night the guest rents the room, the resort issues a credit to the guest in the amount of seventy five dollars. The resort also contains a casino. The credit issued for the room rental is in the form of a gambling credit, which may be used at any time only within the casino(s) associated with the resort. The itemized bill for the room rental reflects only a room charge and does not reflect the gaming credit received, thereby preserving that anonymity and privacy of the guest in relation to the gaming credit.

What is claimed is:

1. A method of providing a credit to a customer comprising:
a. providing a requested material to a customer for a fee, wherein the requested material is provided by a seller and further wherein the requested material is selected from the group consisting of a good, a service or a combination thereof; and
b. returning to the customer at least ten percent of the fee as a credit, wherein the credit has no cash value.

2. The method of claim 1, wherein at least twenty five percent of the fee is refunded as a credit.

3. The method of claim 1, wherein at least fifty percent of the fee is refunded as a credit.

4. The method of claim 1, wherein the credit may only be used to purchase one or more non-staple items.

5. The method of claim 4, wherein the non-staple item is a gambling credit which cannot be redeemed for cash but may only be used for gambling, wherein any winnings resulting from said gambling may be redeemed for cash.

6. The method of claim 5, wherein the gambling credit may only be used with the seller.

7. The method of claim 1, wherein the requested material is a staple item.

8. The method of claim 7, wherein the staple item is selected from the group consisting of a food, a beverage, a room rental or a combination thereof.

9. The method of claim 8, wherein the staple item is a food.

10. The method of claim 1, wherein the seller is a selected from the group consisting of a casino or a resort.

11. A method of providing a credit to a customer comprising:
a. providing a requested material to a customer for a fee, wherein the requested material is provided by a seller, and further wherein the requested material is selected from the group consisting of a good, a service or a combination thereof, and
b. returning to the customer a portion of the fee as a credit, wherein the credit can only be used to purchase one or more non-staple items.

12. The method of claim 11, wherein the non-staple item is a gambling credit.

13. The method of claim 11, wherein the non-staple items must be purchased from the seller.

14. The method of claim 11, wherein the requested material is a good.

15. The method of claim 14, wherein the good is selected from the group consisting of a food item, a beverage item or a combination thereof.

16. The method of claim 11, wherein the requested material is a service.

17. The method of claim 16, wherein the service is a lodging rental.

18. A method of providing a credit to a customer comprising:
a. providing a requested material to a customer for a fee, wherein the requested material is provided by a seller, and further wherein the requested material is selected from the group consisting of a good, a service or a combination thereof; and
b returning a portion of the fee as a credit to the customer, wherein the credit is not listed on a receipt provided by the seller to the customer, and wherein the requested material is listed on the receipt.

19. The method of claim 18, wherein the receipt is delivered to the customer less than one hour after payment of the fee by the customer.
